(19) United States
(12) Patent Application Publication
(10) Pub. No.: US 2020/0309537 A1
(43) Pub. Date: Oct. 1, 2020

(54) SEARCHLIGHT UNIT WITH TERRAIN MAPPING CAPABILITY

(71) Applicant: HONEYWELL INTERNATIONAL INC., Morris Plains, NJ (US)

(72) Inventors: Abhijit Kulkarni, Bangalore (IN); Sunit Kumar Saxena, Bangalore (IN); Kartik Brahmbhatt, Bangalore (IN); Gokul Murugesan, Bangalore (IN); Deepak Bhimrao Mahajan, Bangalore (IN); Senthil Kumar S, Bangalore (IN)

(73) Assignee: HONEYWELL INTERNATIONAL INC., Morris Plains, NJ (US)

(21) Appl. No.: 16/366,016

(22) Filed: Mar. 27, 2019

(51) Int. Cl. G01C 21/32; G01S 19/45

(52) U.S. Cl. CPC G01C 21/32; G01S 19/45

(57) ABSTRACT

Systems and methods for using a searchlight unit to obtain elevation information about a point of interest are disclosed herein. The searchlight unit comprises an illumination source, a distance measurement system and an actuator for positioning the illumination source and for positioning the distance measurement system toward the point of interest. The searchlight unit also includes a global navigation satellite system and an inertial measurement unit for obtaining position and orientation information about the searchlight unit.

### TECHNICAL FIELD

The present disclosure generally relates to searchlights, and more particularly relates to searchlights having terrain mapping capability.

### BACKGROUND

Terrain mapping systems are conventionally used to obtain elevation information about environmental features in a particular geographical area. Conventional terrain mapping systems are normally mounted on airborne vehicles, such as helicopters or unmanned aerial vehicles (e.g., UAVs or drones).

Terrain maps need to be validated or updated as the geography of an area develops, for example due to construction work or physical phenomena causing a change in geographical topography of an area. The initial development of the terrain map and any subsequent updating of the terrain map is conventionally performed using a standalone terrain mapping system. Existing standalone terrain mapping systems are usually bulky, thereby reducing the space available for other components on the airborne vehicle.

Accordingly, it would be desirable to decrease the space requirements associated with incorporating a terrain mapping system onto an airborne vehicle. Other desirable features and characteristics will become apparent from the subsequent detailed description and appended claims.

### BRIEF SUMMARY

This summary is provided to introduce a selection of concepts in a simplified form that are further described below in the detailed description section. This summary is provided to describe select concepts in a simplified form that are further described in the Detailed Description. This summary is not intended to identify key or essential features of the claimed subject matter, nor is it intended to be used as an aid in determining the scope of the claimed subject matter.

In an exemplary embodiment, there is provided a computer-implemented method of using a searchlight unit comprising an illumination source, a distance measurement system, at least one actuator for positioning the illumination source and for positioning the distance measurement system, a global navigation satellite system for determining a position of the searchlight system and an inertial measurement unit for determining an orientation of the searchlight system. The computer-implemented method includes the step of receiving, at a processor module, a location of a point of interest and positioning, using the at least one actuator, the illumination source and the distance measurement system to be directed toward the point of interest. The computer-implemented method also includes the step of determining, using the global navigation satellite system and the inertial measurement unit, a position and an orientation of the searchlight unit, and determining, using the distance measurement system, the distance between the point of interest and the position of the searchlight unit. The computer-implemented method also includes the step of determining, using the processor module, elevation information about the point of interest from the determined position and orientation of the searchlight unit and the determined distance of the point of interest from the position of the searchlight unit; and storing, using the processor, the determined elevation information about the point of interest in a terrain mapping database.

In another exemplary embodiment, there is provided a computer-implemented method of using a searchlight unit comprising an illumination source, a distance measurement system, at least one actuator for positioning the illumination source and for positioning the distance measurement system, a global navigation satellite unit for determining a position of the searchlight system and an inertial measurement unit for determining an orientation of the searchlight unit. The computer-implemented method includes the step of receiving, at a processor module, an area defining locations of multiple points of interest, and determining an acquisition pattern for an order to determine elevation information about the multiple points of interest. The computer-implemented method also includes the step of positioning, using the at least one actuator, the illumination source and the distance measurement system to be directed toward a first point of interest of the multiple points of interest, and determining, using the global navigation satellite system and the inertial measurement unit, a position and an orientation of the searchlight unit. The computer-implemented method also includes the step of determining, using the distance measurement system, the distance between the first point of interest and the position of the searchlight unit. The computer-implemented method also includes the step of determining, using the processor module, elevation information about the first point of interest from the determined position and orientation of the searchlight unit and the determined distance of the first point of interest from the position of the searchlight unit and storing, using the processor module, the determined elevation information about the first point of interest in a terrain mapping database. After elevation information about the first point of interest has been determined, the method is optionally repeated so as to determine elevation for subsequent (second, third, etc.) points of interest of the multiple points of interest.

In another exemplary embodiment, there is provided a searchlight unit comprising an illumination source and a distance measurement system. The searchlight unit further comprises at least one actuator for positioning the illumination source and for positioning the distance measurement system. The searchlight unit further comprises a global navigation satellite system for determining a position of the searchlight unit an inertial measurement unit for determining an orientation of the searchlight unit. The searchlight unit further includes an inertial measurement unit, a terrain mapping database; and a processor module. The processor module is configured to, upon receipt of a location of a point of interest, cause the at least one actuator to position the illumination source and the distance measurement system to be directed toward the point of interest. The processor module is further configured to cause the global navigation satellite system and the inertial measurement unit to determine a position and an orientation of the searchlight unit, and to cause the distance measurement system to determine the distance between the point of interest and the position of the searchlight unit. The processor module is further configured to determine elevation information about the point of interest from the determined position and orientation of the searchlight unit and the determined distance of the point of interest from the position of the searchlight unit, and to store the determined elevation information about the point of interest in a terrain mapping database.

Furthermore, other desirable features and characteristics of the disclosed system and method will become apparent from the subsequent detailed description, taken in conjunction with the accompanying drawings and the preceding background.

### BRIEF DESCRIPTION OF THE DRAWINGS

A more complete understanding of the subject matter may be derived from the following detailed description taken in conjunction with the accompanying drawings, wherein like reference numerals denote like elements, and wherein:

FIG. 1 shows a schematic of a searchlight unit in accordance with exemplary embodiments;

FIG. 2 shows a schematic of a method of obtaining elevation information about a point of interest using a searchlight unit in accordance with various embodiments;

FIG. 3 shows a flowchart illustrating a method in accordance with various embodiments; and

FIG. 4 shows a flowchart illustrating a method in accordance with various embodiments.

### DETAILED DESCRIPTION

The following detailed description is merely illustrative in nature and is not intended to limit the embodiments of the subject matter or the application and uses of such embodiments. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the systems and methods defined by the claims. As used herein, the term “module” refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. There is no intention to be bound by any expressed or implied theory presented in the preceding Technical Field, Background, Brief Summary or the following Detailed Description.

For the sake of brevity, conventional techniques and components may not be described in detail herein. Furthermore, any connecting lines and arrows shown in the various figures contained herein are intended to represent example functional relationships and/or physical couplings between the various elements. It should be noted that many alternative or additional functional relationships or physical connections may be present in an embodiment of the present disclosure.

It has been recognized by the present inventors that terrain mapping capability may be introduced into a searchlight unit, thereby combining both of the searchlight and terrain mapping functions into a single unit to be mounted on the airborne vehicle to thereby reduce the space requirements needed for including a terrain mapping system on the airborne vehicle. Furthermore, it has been recognized by the inventors that some existing searchlight unit include components which are also present in terrain mapping systems or would provide a terrain mapping system with additional functionality. By incorporating terrain mapping capability into a searchlight unit, these components can be shared between these two systems, and an overall reduction in the number of components required and the space required for both searchlight and terrain mapping capabilities can be achieved.

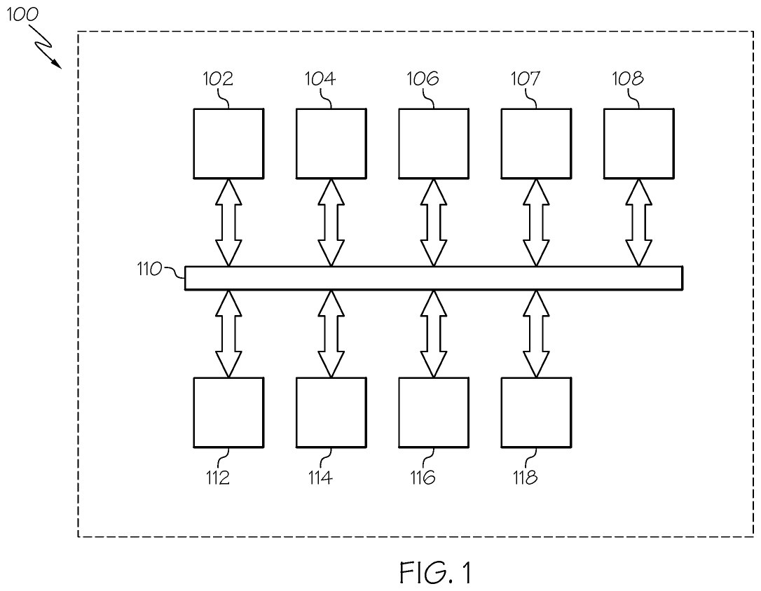

FIG. 1 shows an exemplary schematic of a searchlight unit 100 having a terrain mapping capability. Searchlight unit 100 includes an illumination source 102 configured to emit illumination. In various exemplary embodiments, the illumination source 102 includes one or more light emitting semiconductor devices, for example LEDs. The searchlight unit 100 further includes a distance measurement system 104 configured to determine the distance from the searchlight unit 100 to a point of interest, as will be explained in more detail below. In an exemplary embodiment, the distance measurement system 104 comprises a laser distance measurement unit. The searchlight unit 100 further includes at least one actuator 106 for positioning the illumination source 102 and for positioning the distance measurement system 104. In an exemplary embodiment, the at least one actuator 106 includes one or more pistons or motors connected to the illumination source 102 and the distance measurement system 104 and configured to alter the angle of the illumination source 102 and/or the distance measurement system 104. For example, the at least one actuator 106 is configured to alter the position of the illumination source 102 and the distance measurement system 104 via linear movements and/or pan/tilt movements, amongst other types of movement. In an exemplary embodiment, the at least one actuator 106 is further configured to extend or retract the illumination source 102 from a housing (not shown) of the searchlight unit 100 when the searchlight functionality is desired.

The searchlight unit 100 further includes a global navigation satellite system (GNSS) 107 for determining a position of the searchlight unit 100. In an embodiment, the GNSS 107 comprises a global positioning system (GPS). The searchlight unit 100 further includes an inertial measurement unit 108 for determining an orientation of the searchlight unit 100. In an exemplary embodiment, the inertial measurement unit 108 comprises one or more motion sensors (such as accelerometers) and/or one or more rotation sensors (such as gyroscopes) configured to determine the orientation and velocity of the searchlight unit 100. Preferably, the inertial measurement unit 108 comprises at least one gyroscope so as to continuously monitor the absolute angular orientation of the searchlight unit 100.

The searchlight unit 100 further includes a processor module 110 operably connected to each one of the distance measurement system 104, the global navigation satellite system 107 and the inertial measurement unit 108. The operable connection between the processor module 110 and each one of the distance measurement system 104, the global navigation satellite system 107 and the inertial navigation system 108 allows for the transmission of information between each one of these components and the processor module 110. In an exemplary embodiment, the processor module 110 is additionally operably connected to the one or more of the illumination source 102 and the at least one actuator 106.

The searchlight unit 100 further includes a user interface module 112 operably connected to the processor module 110. The operable connection between the user interface module 112 and the processor module 110 may be a communication channel, such as a wired connection or a wireless connection. In the embodiment where a wired connection is provided, the user interface module 112 may be integrated into the vehicle's operating system or may form part of an electronic flight bag (EFB). In the embodiment where a wireless connection is provided, the user interface module 112 may be included on a remote device, such as a handheld tablet (for example an iPad™), mobile phone, digital personal assistant or other such remote device having wireless connectivity. The user interface module 112 is configured to receive inputs from a user and to transmit instructions associated with these inputs to the processor module 110. In an exemplary embodiment, the user interface module 112 is configured to receive an input from a user associated with a terrain point of interest. In an exemplary embodiment, the user interface module 112 is configured to present terrain information in the form of a map, and the user may select locations of points of interest through selection of a point on the displayed map.

In use, the searchlight unit 100 is configured to obtain elevation information about points of interest. In particular, a user may interact with the user interface module 112 to specify a location of a point of interest for terrain mapping. The specified location of the point of interest is transmitted to the processor module 110. The processor module 110 is then configured to control, using the at least one actuator 106, the position and angle of the distance measurement system 104 such that this distance measurement system 104 is positioned toward the point of interest. In exemplary embodiments, the at least one actuator 106 also controls the position of the illumination source 102 such that positioning the distance measurement system 104 toward the point of interest also positions the illumination source 102 such that the illumination source 102 is also positioned towards the point of interest.

After the distance measurement system 104 is positioned toward the point of interest, the distance measurement system 104 is configured to determine the distance to the point of interest from the searchlight unit 100. Based on this distance, and on the information provided from the global positioning system 107 and the inertial navigation system 108, the processor module 110 can determine elevation information of the object of interest.

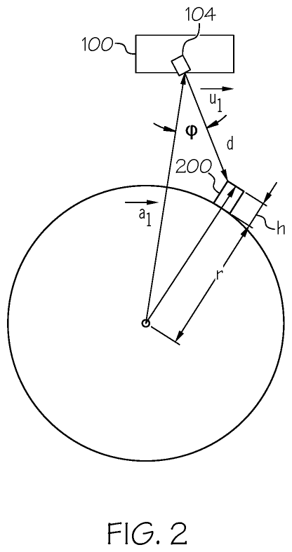

One exemplary manner of determining elevation information about the object of interest is described below with respect to FIG. 2. As can be seen in FIG. 2, the searchlight unit 100 is positioned with the distance measurement unit 104 directed toward a point of interest on top of a building 200. As can be seen in FIG. 2, the distance vector \vec{a₁} is the distance vector given by the GNSS 107 with respect to a co-ordinate frame having its origin at the earth's center. The inertial measurement unit 108 inside the searchlight unit 100 gives the line-of-sight unit vector \vec{u₁} from the searchlight unit 100 to the point of interest. The distance measurement unit 104 gives the distance d between the searchlight unit 100 and the point of interest.

A straight-line can be assumed to connect the earth's center to the point of interest. The two sides (∥\vec{a₁}∥, d) and an angle (φ) of a triangle shown in FIG. 2 are known. Thus, it is possible to compute the distance r+h shown in FIG. 2. Deviation of r+h from the mean radius of the earth at the co-ordinates of the point of interest provides the terrain information (h). For example, if the computed r+h equals the mean earth radius, the implication is that the point of interest is at the mean sea level of the earth. Any deviation from this mean sea level essentially provides the altitude information at the point of interest.

In particular, if magnitude of the vector, ∥\vec{a₁}∥=a₁, then, using the geometry shown in FIG. 2, it can be shown that,

r+h=\sqrt{a₁²+d²−2a₁d cos φ} (1)

The resolution of the terrain data is dependent upon on the update rate of the distance measurement sensor 104, the GNSS 107 and the inertial measurement unit 108. and the speed at which the searchlight unit 100 is moving. Thus, it is possible to obtain the terrain data at a particular resolution by controlling the speed at which the vehicle upon which the searchlight unit 100 is mounted is moving.

In an exemplary embodiment, the processor module 110 is configured to illuminate the point of interest with the illumination source 102 during acquisition of elevation information. By illumination of the point of interest with the illumination source 102 during acquisition of elevation information, a user can visually determine if the point of interest was correctly chosen using the user interface module 112.

In an exemplary embodiment, and referring again to FIG. 1, after determining elevation information about the point of interest, the processor module 110 is configured to store this elevation information in a terrain database 114 operably connected to the processor module 100. The terrain database 114 may form part of the searchlight unit 100 or may be remote from the processor module 110 and be updated with the elevation information on a continuous or a non-continuous regular basis via updates. The elevation information stored in the terrain database 114 can be used for the construction of a new terrain map, or for validation or updating of an existing terrain map.

In exemplary embodiments, a user can select different terrain information acquisition programs stored in a memory 116 operably connected to the processor module 110. In an exemplary embodiment, the user may specify for the searchlight unit 100 to obtain elevation information for a series of co-ordinates. In particular, the user may enter a series of co-ordinates into the user interface module 112. These co-ordinates may be entered individually by the user or may be determined by the processor module 110 in response to an area being specified in the user interface module 112 by the user. For example, the user may define an area on a map displayed in the user interface module 112 and the processor module 110 may determine the co-ordinates of points inside the user-defined area.

In an exemplary embodiment, after determination of the points of interest, the processor module 110 is configured to obtain elevation information for each one of the specified points of interest in the manner as set out above. In an alternative exemplary embodiment, the processor module 110 may determine elevation information for a subset of the specified points in the defined area in a pre-defined pattern. The number of points to be included in the subset of specified points may be automatically determined by the processor module 110 based on a selected resolution specified by the user using the user interface module 112. In particular, the user may select, using the user interface 112, a desired resolution of the elevation information to be obtained. The processor module 110 may then compare this desired resolution to different spacings and patterns for selecting points of interest over a given area stored in a look-up table in the memory 116. By altering the resolution of the elevation information to be obtained, the time taken for obtaining the elevation information for the pre-defined area may also be adjusted, since more or less points of interest can be selected for the obtaining of elevation information.

In an exemplary embodiment, the searchlight unit 100 includes an image capture device 118, for example a camera. In exemplary embodiments, the processor module 110 is configured to cause the image capture device 118 to capture an image of the point of interest concurrently with determining elevation information. The captured images may be stored in the terrain database 114 and later retrieved so as to allow for a comparison by a user between the determined terrain elevation information and the captured image. This comparison allows for a user to obtain further information about the terrain or to ensure that the searchlight unit 100 is operating correctly.

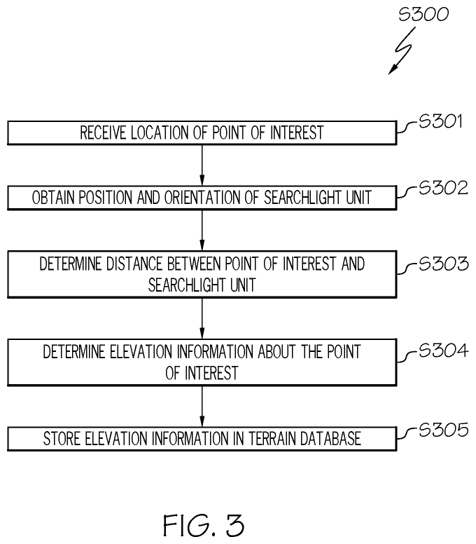

Referring now to FIG. 3, a flowchart of a method S300 for obtaining elevation information using a searchlight unit is shown.

At step S301, a location of a point of interest is received at a processor module. In exemplary embodiments, the point of interest is specified by a user using a user interface module. The method then progresses to step S302.

At step S302, a position and orientation of a searchlight unit are obtained using a GNSS and an inertial measurement unit, respectively. In exemplary embodiments, the GNSS comprises a global positioning system (GPS) and the inertial measurement unit includes a gyroscope. The method then progresses to step S303.

At step S303, a distance between the point of interest and the searchlight unit is determined using a distance measurement unit. The method then progresses to step S304.

At step S304, elevation information about the point of interest is determined, using the processor module, based on the obtained position and orientation information of the searchlight unit and the distance between the searchlight unit and the point of interest. The method then progresses to step S305.

At step S305, the elevation information is stored, using the processor module, in a terrain database.

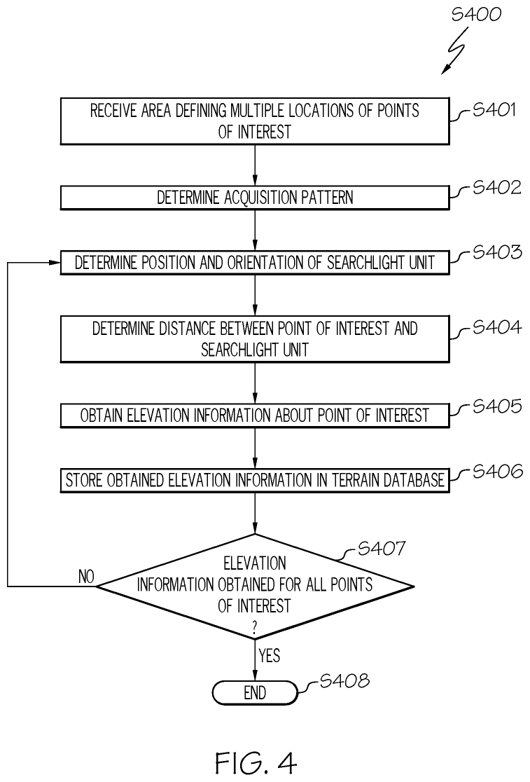

Referring now to FIG. 4, a flowchart of another method S400 for obtaining elevation information using a searchlight unit is shown.

At step S401, an area defining multiple points of interest is received at a processor module. In exemplary embodiments, the multiple points of interest are specified by a user using a user interface module. In an exemplary embodiment, the multiple points of interest are specified by a user designating a defined area on a map displayed on the user interface module. The multiple points of interest comprise a subset of the points within the defined area in the map. The method then progresses to step S402.

At step S402, an acquisition pattern for the order of points of interest about which elevation information should be acquired is determined using the processor module. In an exemplary embodiment, the processor module determines the order of points of interest by mapping a pre-determined acquisition pattern onto the area of interest and selecting points of interest falling within the pre-determined acquisition pattern. In an exemplary embodiment, the acquisition pattern is determined by the processor module using a desired resolution selected by a user. The method then progresses to step S403.

At step S403, a position and orientation of a searchlight unit are obtained using a GNSS and an inertial measurement unit, respectively. The method then progresses to step S404.

At step S404, a distance between the first point of interest and the searchlight unit is determined using a distance measurement unit. The method then progresses to step S405.

At step S405, elevation information about the first point of interest is determined, using the processor module, based on the obtained position and orientation information of the searchlight unit and the distance between the searchlight unit and the first point of interest. The method then progresses to step S406.

At step S406, the elevation information is stored, using the processor module, in a terrain database. The method progresses to step S407.

At step S407, it is determined, using the processor module, whether elevation information about all of the multiple points of interest has been acquired. If this determination is negative, the method reverts to step S403 and elevation information is acquired for the subsequent point of interest in the same manner The position and the orientation of the searchlight unit is obtained for each one of the multiple points of interest, since the vehicle upon which the searchlight unit is mounted is typically moving during the method S400. If this determination is positive, the method terminates at step S408.

Those of skill in the art will appreciate that the various illustrative logical blocks, modules, circuits, and algorithm steps described in connection with the embodiments disclosed herein may be implemented as electronic hardware, computer software, or combinations of both. Some of the embodiments and implementations are described above in terms of functional and/or logical block components (or modules) and various processing steps. However, it should be appreciated that such block components (or modules) may be realized by any number of hardware, software, and/or firmware components configured to perform the specified functions. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention. For example, an embodiment of a system or a component may employ various integrated circuit components, e.g., memory elements, digital signal processing elements, logic elements, look-up tables, or the like, which may carry out a variety of functions under the control of one or more microprocessors or other control devices. In addition, those skilled in the art will appreciate that embodiments described herein are merely exemplary implementations.

The various illustrative logical blocks, modules, and circuits described in connection with the embodiments disclosed herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC.

Techniques and technologies may be described herein in terms of functional and/or logical block components, and with reference to symbolic representations of operations, processing tasks, and functions that may be performed by various computing components or devices. Such operations, tasks, and functions are sometimes referred to as being computer-executed, computerized, software-implemented, or computer-implemented. In practice, one or more processor devices can carry out the described operations, tasks, and functions by manipulating electrical signals representing data bits at memory locations in the system memory, as well as other processing of signals. The memory locations where data bits are maintained are physical locations that have particular electrical, magnetic, optical, or organic properties corresponding to the data bits. It should be appreciated that the various block components shown in the figures may be realized by any number of hardware, software, and/or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

When implemented in software or firmware, various elements of the systems described herein are essentially the code segments or instructions that perform the various tasks. The program or code segments can be stored in a processor-readable medium or transmitted by a computer data signal embodied in a carrier wave over a transmission medium or communication path. The “computer-readable medium”, “processor-readable medium”, or “machine-readable medium” may include any medium that can store or transfer information. Examples of the processor-readable medium include an electronic circuit, a semiconductor memory device, a ROM, a flash memory, an erasable ROM (EROM), a floppy diskette, a CD-ROM, an optical disk, a hard disk, a fiber optic medium, a radio frequency (RF) link, or the like. The computer data signal may include any signal that can propagate over a transmission medium such as electronic network channels, optical fibers, air, electromagnetic paths, or RF links. The code segments may be downloaded via computer networks such as the Internet, an intranet, a LAN, or the like.

Some of the functional units described in this specification have been referred to as “modules” in order to more particularly emphasize their implementation independence. For example, functionality referred to herein as a module may be implemented wholly, or partially, as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices, or the like. Modules may also be implemented in software for execution by various types of processors. An identified module of executable code may, for instance, comprise one or more physical or logical modules of computer instructions that may, for instance, be organized as an object, procedure, or function. Nevertheless, the executables of an identified module need not be physically located together, but may comprise disparate instructions stored in different locations that, when joined logically together, comprise the module and achieve the stated purpose for the module. Indeed, a module of executable code may be a single instruction, or many instructions, and may even be distributed over several different code segments, among different programs, and across several memory devices. Similarly, operational data may be embodied in any suitable form and organized within any suitable type of data structure. The operational data may be collected as a single data set, or may be distributed over different locations including over different storage devices, and may exist, at least partially, merely as electronic signals on a system or network.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth herein.

What is claimed is:

1. A computer-implemented method of using a searchlight unit comprising an illumination source, a distance measurement system, at least one actuator for positioning the illumination source and for positioning the distance measurement system, a global navigation satellite system for determining a position of the searchlight system and an inertial measurement unit for determining an orientation of the searchlight system, the computer-implemented method comprising:
receiving, at a processor module, a location of a point of interest;
positioning, using the at least one actuator, the illumination source and the distance measurement system to be directed toward the point of interest;
determining, using the global navigation satellite system and the inertial measurement unit, a position and an orientation of the searchlight unit;
determining, using the distance measurement system, the distance between the point of interest and the position of the searchlight unit;
determining, using the processor, elevation information about the point of interest from the determined position and orientation of the searchlight unit and the determined distance of the point of interest from the position of the searchlight unit; and
storing, using the processor, the determined elevation information about the point of interest in a terrain mapping database.

2. The computer-implemented method of claim 1, further comprising the step of illuminating the point of interest using the illumination source.

3. The computer-implemented method of claim 1, further comprising the step of performing an image capture of the point of interest using an image capture device.

4. The computer-implemented method of claim 1, further comprising the step of selecting the location of the point of interest using a user-interface module, wherein the location of the point of interest is transmitted to the processor module from the user-interface module using a communication channel.

5. The computer-implemented method of claim 4, wherein the user-interface module comprises an interactive map, and wherein the step of selecting the location of the point of interest comprises selecting a point on the interactive map.

6. The computer-implemented method of claim 1, wherein the global positioning navigation satellite system comprises a global positioning system and wherein the inertial measurement unit comprises a gyroscope.

7. A computer-implemented method of using a searchlight unit comprising an illumination source, a distance measurement system, at least one actuator for positioning the illumination source and for positioning the distance measurement system, a global navigation satellite unit for determining a position of the searchlight system and an inertial measurement unit for determining an orientation of the searchlight unit, the computer-implemented method comprising:
(i) receiving, at a processor module, an area defining locations of multiple points of interest;
(ii) determining an acquisition pattern for an order to determine elevation information about the multiple points of interest;
(iii) positioning, using the at least one actuator, the illumination source and the distance measurement system to be directed toward a first point of interest of the multiple points of interest;
(iv) determining, using the global navigation satellite system and the inertial measurement unit, a position and an orientation of the searchlight unit;
(v) determining, using the distance measurement system, the distance between the first point of interest and the position of the searchlight unit;
(vi) determining, using the processor module, elevation information about the first point of interest from the determined position and orientation of the searchlight unit and the determined distance of the first point of interest from the position of the searchlight unit;
(vii) storing, using the processor module, the determined elevation information about the first point of interest in a terrain mapping database; and
(viii) repeating steps (iii) to (vii) for a second point of interest different to the first point of interest.

8. The computer-implemented method of claim 7, further comprising determining whether elevation information has been obtained about all of the multiple points of interest and, if elevation information hasn't been obtained about all of the multiple points of interest, performing the steps of (iii) to (vii) for a subsequent point of interest different to the first and second points of interest.

9. The computer-implemented method of claim 7, further comprising the step of illuminating at least one of the multiple points of interest using the illumination source.

10. The computer-implemented method of claim 7, further comprising the step of performing an image capture of the at least one of the multiple points of interest using an image capture device.

11. The computer-implemented method of claim 7, further comprising the step of selecting the locations of the multiple points of interest using a user-interface module, wherein the locations of the multiple points of interest are transmitted to the processor module from the user-interface module using a communication channel.

12. The computer-implemented method of claim 11, wherein the user-interface module comprises an interactive map, and wherein the step of selecting the location of the point of interest comprises defining an area on the interactive map.

13. The computer-implemented method of claim 7, wherein the step of determining, using the processor module, an acquisition pattern for an order to determine elevation information about the multiple points of interest comprises determining a subset of the received multiple points of interest about which elevation information should be obtained.

14. The computer-implemented method of claim 13, wherein the step of determining a subset of the received multiple points of interest about which elevation information should be obtained comprises receiving a desired resolution at the processor module and using the desired resolution in the determination.

15. A searchlight unit comprising:
an illumination source,
a distance measurement system,
at least one actuator for positioning the illumination source and for positioning the distance measurement system,
a global navigation satellite system for determining a position of the searchlight unit an inertial measurement unit for determining an orientation of the searchlight unit;
an inertial measurement unit;
a terrain mapping database; and
a processor module, the processor module configured to, upon receipt of a location of a point of interest:
cause the at least one actuator to position the illumination source and the distance measurement system to be directed toward the point of interest;
cause the global navigation satellite system and the inertial measurement unit to determine a position and an orientation of the searchlight unit;
cause the distance measurement system to determine the distance between the point of interest and the position of the searchlight unit;
determine elevation information about the point of interest from the determined position and orientation of the searchlight unit and the determined distance of the point of interest from the position of the searchlight unit; and
store the determined elevation information about the point of interest in a terrain mapping database.

16. The system of claim 15, further comprising a user interface module configured to receive a location of interest from a user and transmit the location of the point of interest to the processor module.

17. The system of claim 16, wherein the user interface module is separate from the searchlight unit and configured to transmit the location of the point interest via a communication channel

18. The system of claim 15, further comprising an image capture device configured to capture an image of the point of interest.

19. The system of claim 15, further comprising a memory configured to store one or more acquisition patterns for determining the order in which elevation information should be acquired for multiple points of interest.

20. The system of claim 15, wherein the global navigation satellite system comprises a global position system (GPS) and the inertial measurement unit comprises a gyroscope.
